(19) United States
(12) Patent Application Publication
(10) Pub. No.: US 2012/0179476 A1
(43) Pub. Date: Jul. 12, 2012

(54) METHOD AND SYSTEM OF REMUNERATION FOR PROVIDING SUCCESSFUL SALES LEADS

(76) Inventor: MICHAEL MUNCY, Rockville, MD (US)

(21) Appl. No.: 13/005,320

(22) Filed: Jan. 12, 2011

(51) Int. Cl. G06Q 10/00

(52) U.S. Cl. 705/1.1

(57) ABSTRACT

A computer-implemented method, system, and program product are provided for ensuring payment for a successful sales lead that is provided to a product vendor. A plurality of customer leads are received from a lead provider web site, the customer leads including at least customer information and a product preference. The customer leads are stored in a plurality of records in a leads database. The plurality of lead records in the leads database is filtered to validate customer information and product availability. A lead acquisition algorithm is applied to the filtered lead records to determine a plurality of leads to acquire. A lead distribution algorithm is applied to determine at least one product vendor to send each acquired lead. A product vendor sales management database is accessed to determine the acquired leads that have resulted in product sales to customers associated with the acquired leads. The acquired leads stored in the leads database are compared with a plurality of sales records stored in a sales database to determine matched pairings of acquired leads and product sales. Payment due from the at least one product vendor is determined and billed based on the matched pairings of acquired leads and product sales.

### TECHNICAL FIELD

Embodiments of the invention are generally directed to the field of information processing. More particularly, the embodiments of the invention are directed to remuneration for providing successful sales leads.

### BACKGROUND OF THE INVENTION

Sales leads typically include customer information such as product or service interest and identifying information sufficient to contact the potential customer. Sales leads may be obtained from a wide variety of sources, including personal communications, web sites, filled-out cards or forms, and other means. Sales leads obtained by one entity may be sold to another entity. Ultimately, a lead provider sells the sales lead to a “seller” who can provide the desired product or service to the customer. However, since not all sales leads result in a sale, sellers are reluctant to pay significant amounts for any given sales lead.

### SUMMARY OF THE INVENTION

In one embodiment, a computer-implemented method is provided for ensuring payment for a successful sales lead to a product vendor. A plurality of customer leads are received from a lead provider web site, the customer leads including at least customer information and a product preference. The customer leads are stored in a plurality of records in a leads database. The plurality of lead records in the leads database is filtered to validate customer information and product availability. A lead acquisition algorithm is applied to the filtered lead records to determine a plurality of leads to acquire. A lead distribution algorithm is applied to determine at least one product vendor to send each acquired lead. A product vendor sales management database is accessed to determine the acquired leads that have resulted in product sales to customers associated with the acquired leads. The acquired leads stored in the leads database are compared with a plurality of sales records stored in a sales database to determine matched pairings of acquired leads and product sales. Payment due from the at least one product vendor is determined and billed based on the matched pairings of acquired leads and product sales.

### BRIEF DESCRIPTION OF THE DRAWINGS

These and other advantages and aspects of the embodiments of the invention will become apparent and more readily appreciated from the following detailed description of the embodiments taken in conjunction with the accompanying drawings, as follows.

FIG. 1 illustrates a simplified exemplary embodiment of an electronic environment for implementation of the system for monetization of successful vehicle leads.

FIG. 2 illustrates an overview of the processing logic for remuneration of successful sales leads provided by the transaction pairing service provider in an exemplary embodiment.

FIG. 3 illustrates the processing logic for the Lead Hygiene engine which filters and validates leads stored in the raw lead database in an exemplary embodiment.

FIG. 4 illustrates the processing logic for the Lead Closing Prediction engine which predicts closings for leads in an exemplary embodiment.

FIG. 5 illustrates the processing logic for the Lead Acquisition engine in an exemplary embodiment.

FIG. 6 illustrates the processing logic for the Lead Distribution engine in an exemplary embodiment.

FIG. 7 illustrates the processing logic for Transaction Pairing engine that matches sales to lead inventory in an exemplary embodiment.

FIG. 8 illustrates the processing logic for the Asynchronous Transaction Clearing engine in an exemplary embodiment.

FIG. 9 illustrates the processing logic for the Dealer Rating engine in an exemplary embodiment.

### DETAILED DESCRIPTION

The following description is provided as an enabling teaching of embodiments of the invention including the best, currently known embodiment. Those skilled in the relevant art will recognize that many changes can be made to the embodiments described, while still obtaining the beneficial results. It will also be apparent that some of the desired benefits of the embodiments described can be obtained by selecting some of the features of the embodiments without utilizing other features. Accordingly, those who work in the art will recognize that many modifications and adaptations to the embodiments described are possible and may even be desirable in certain circumstances. Thus, the following description is provided as illustrative of the principles of the embodiments of the invention and not in limitation thereof, since the scope of the invention is defined by the claims.

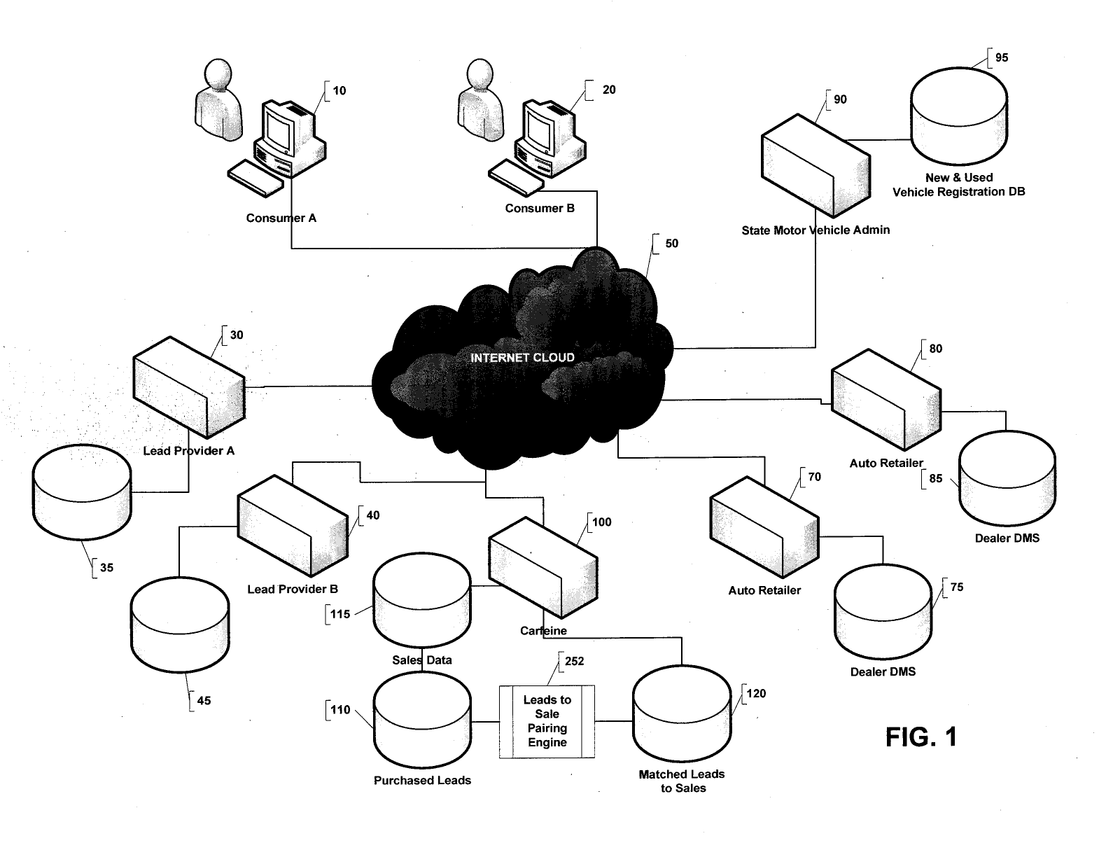

FIG. 1 illustrates a simplified exemplary embodiment of an electronic environment for implementation of the system for remuneration of successful vehicle leads. Although FIG. 1 depicts a limited number of system participants, there are no specific limitations in the actual implementation of the system. A successful lead is a lead that has been provided to an auto retailer and has resulted in a vehicle purchase by the consumer. Consumers using personal computers 10, 20 are sales leads representing potential customers for an auto retailer. Information provided by the consumers' computers 10, 20 is obtained over the Internet 50 by one or more lead provider servers 30, 40 having lead databases 35, 45, respectively. Transaction pairing service provider server 100 acquires selected leads from lead provider servers 30, 40 which are then offered for sale to auto retailers through servers 70, 80 via the Internet 50. Transaction pairing service provider server 100 maintains a plurality of databases including Sales database 115, Augmented Leads database 110, and Paired Leads and Sales database 120. A Transaction Pairing Engine 252 matches leads in the Augmented Leads database 110 with vehicle sales data in the Sales database 115, and stores the pairings in Paired Leads and Sales database 120. The leads acquired by service provider server 100 are offered to one or more auto retailers through servers 70, 80 via the Internet 50. The auto retailers' servers 70, 80 maintain Dealer Management System (DMS) databases 75, 85, respectively. The transaction pairing service provider server 100 accesses Dealer Management System databases 75, 85 to retrieve vehicle sales data stored in the DMS for each retailer. Sales records in auto retailer DMS databases 75, 85 are validated by comparing the sales records with records received via the Internet 50 from state motor vehicle administrator servers 90 and stored in State Government Vehicle Registration database 95.

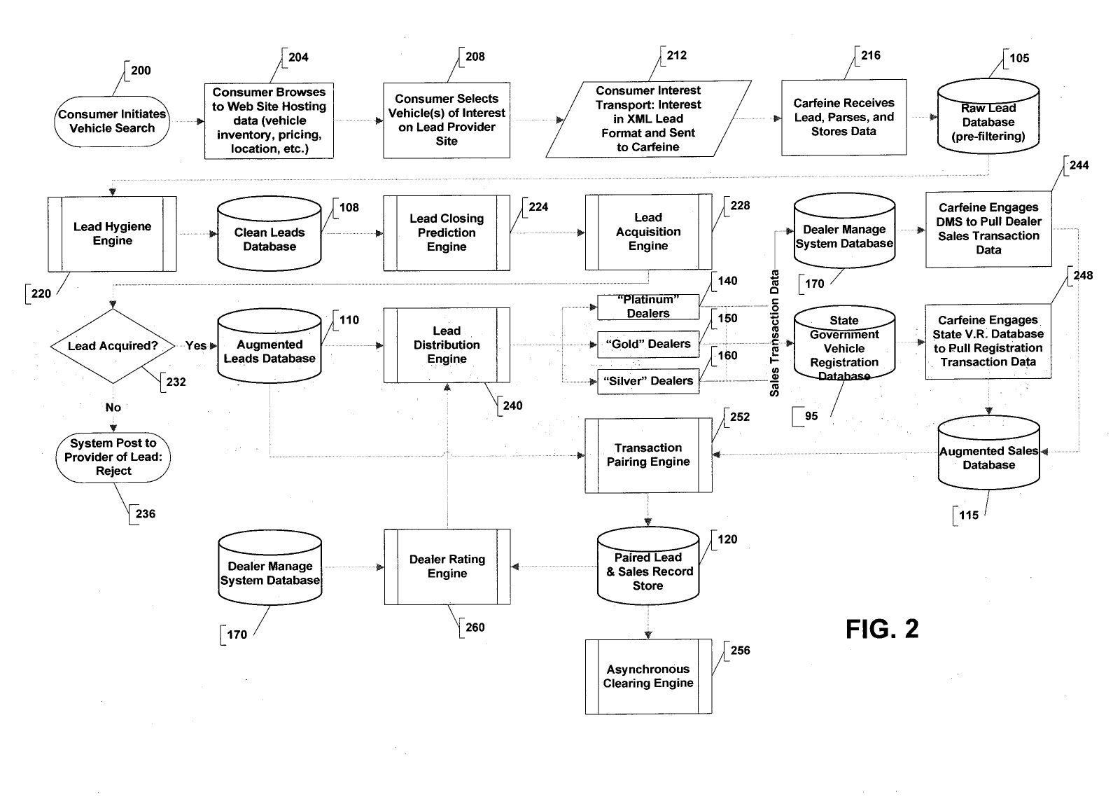

FIG. 2 illustrates the processing logic for remuneration of successful sales leads (i.e., “Pay for Performance” platform) provided by the transaction pairing service provider server 100 in an exemplary embodiment. In the exemplary embodiment shown, the Pay for Performance platform includes six operations modules, seven processing engines, and six databases as described herein. The operations modules include consumer engagement module 204, consumer vehicle selection module 208, consumer interest transport: send module 212, consumer transport: receive module 216, DMS polling module 244, and DMV/MVA polling module 248. The processing engines include Lead Hygiene engine 220, Lead Closing Prediction engine 224, Lead Acquisition engine 228, Lead Distribution engine 240, Transaction Pairing engine 252, Asynchronous Clearing engine 256, and Dealer Rating engine 260. The data stores include Raw Leads database 105, Clean Leads database 108, Augmented Leads database 110, Dealer Management System database 170, State Vehicle Registration database 95, Augmented Sales database 115, and Paired Lead and Sales database 120.

Other embodiments can use additional or fewer operations modules, processing engines, and databases. In some embodiments, one or more operations modules, one or more processing engines, and one or more databases can be combined.

The initial action required beginning the interaction among the consumer, lead provider, and transaction pairing service provider is the engagement step. Processing commences in block 200 with a consumer initiating a vehicle search. The consumer uses his Internet browser and navigates to a web site hosting product and/or service data (i.e., lead provider site) as indicated in block 204. In one embodiment, the product can be vehicles offered for sale and the product data can include vehicle inventory, pricing, location, etc. The lead providers can be represented by brands such as Cars.com, Autobytel.com, AOL Auto, and other brands/web sites. The consumer interacts with the lead provider web site and specifies at least one vehicle that he is interested in purchasing on the lead provider site as indicated in block 208. Consumer data in the form of a “lead” is transported via an Internet communication to the transaction pairing service provider platform 100 via the lead originator server 30 and various partner sources as indicated in block 212. The receipt of consumer data is either accomplished via web services or results from parsed data after receipt of an “ADF/XML” lead (i.e., auto dealer lead format in XML). This step is shown in block 216. Auto-lead Data Format (ADF) is an auto industry standard data format for the export and import of automotive customer leads using Extensible Markup Language (XML). Receiving lead data can also be accomplished via an https (i.e., Hypertext Transfer Protocol over Secure Socket Layer) encoded string. The received lead data is stored in a raw lead database 105 so that the lead data can be processed for accuracy.

Data integrity is of unknown quality and accuracy coming from lead providers. To better serve the needs of customers and the transaction pairing service provider, a process is needed to ensure that the processing of leads is not impaired by bad, out of date, or incomplete data. The Lead Hygiene engine 220 looks at the lead request timestamp compared to the system timestamp. If the lead is older than a time-zone corrected four (4) hour window the lead is rejected. If the vehicle requested in the lead is not a valid combination of year, make, model, trim or vehicle identification number (VIN) combination, the lead is also rejected. If the provided consumer's city, state, and zip code combination is not valid, the lead is rejected. If the lead expressing consumer interest in purchasing a vehicle has been received within the previous thirty (30) day period, the lead is also rejected. If the consumer's email, phone, and name are not valid, the lead is rejected. Finally, the given information points are checked against a “Blacklist” database. Any matches with the blacklist result in rejection of the lead. Any leads that pass these steps are then applied to a third party data provider to ensure that all consumer information is up-to date. This data is appended to the lead record to form a “hygienic” lead record. The hygienic lead data is stored after processing in a “Clean” Leads database 108 so that it is available for additional processing.

The lead consumer data is provided to various third party databases and demographic information that matches the consumer is obtained. Credit bureau data is obtained and added to the record for the consumer. These additional details regarding the consumer are run through a Predictive Analytics Model in Lead Closing Prediction engine 224 to determine the consumer's predicted likelihood of purchasing a vehicle. The lead “score,” credit, and demographic information are carried as inputs to the Lead Acquisition engine 228.

Predictive analytics algorithms analyze past performance to assess how likely a consumer is to exhibit a future behavior in order to improve the effectiveness of marketing targeted to the consumer. Multiple predictor variables are combined into a predictive analytics model which can be used to forecast future probabilities with an acceptable level of reliability. In predictive modeling, data is collected, a statistical model is formulated, predictions are made and the model is validated (or revised) as additional data becomes available.

Once the prediction probability is obtained for the consumer, the Lead Acquisition engine 228 reviews the lead as applied against variable consumption controls. The first decision is whether the prediction of purchase index warrants acceptance. If it does, then the vehicle type is applied which takes into account the requested vehicle's condition (new, pre-owned, or certified pre-owned), year, make, model, and trim for acceptance. If accepted, the specifics of the consumer's geographical location are weighed against the configured consumption controls. If accepted, and a specific vehicle was requested, an active inventory check is conducted for acceptance. If accepted, and the periodicity of the control is met (i.e., if the acceptance control is configured according to system timestamp to allow for acceptance), the lead is applied against limits of consumption. If there exists no override and all variable controls have been satisfied, and one or more dealers are able to service the consumer, the lead is acquired for distribution. All appended data for the lead is now stored in an Augmented Leads database 110. This database 110 houses the leads acquired by the transaction pairing service provider for distribution to car dealers. The Augmented Leads database 110 is a repository of information which feeds the Lead Distribution engine 240.

The Lead Distribution engine 240 uses predictive analytics models to accurately rank one or more dealers 140, 150, 160 to receive leads by optimum expected performance. The lead data is pulled from the Augmented Leads database 110. The predicted consumer's score and the consumer's demographics are used to feed a predictive analytics model to determine the average probability of closing the sale independent of dealership. A preliminary set of dealers 140, 150, 160 is obtained, the regional demographics for each dealer are obtained, and the performance index for each dealer in the set is then loaded into a further predictive analytics model to revise the probability of closing for each dealer in the set by multiplying the dealer performance index and average probability of closing. The Lead Distribution engine predictive model is processed resulting in a revised lead closing prediction as a function of the dealer set 140, 150, 160. The revised probability of closing is compared with the current probability of closing via a predictive model. The resulting lead closing predictions are used to order the dealer set 140, 150, 160 by predictive scores. The leads are distributed to “n” dealers ordered by predictive score.

The transaction pairing service provider works with partners to extract sales outcomes and inventory data from the Dealer Management System databases 170 of the retail dealers 140, 150, 160 that are users of the services of the transaction pairing service provider. This process is indicated in logic block 244. The Dealer Management System (DMS) data 170 holds inventory, operations, and sales data which allows the predictive models and engines of the transaction pairing service provider platform 100 to operate with a closed-loop function for ongoing optimization of the predictive models. In one embodiment, this data is received in regular increments to ensure accuracy of the sales and product inventory data via web services.

The transaction pairing service provider platform 100 works with the various Department of Motor Vehicles (DMV) organizations in all 50 states either directly, or through partners as impartial third parties, to enable the further accuracy and reconciliation of sales data that may not be found, i.e., exceptions in the DMS data. The DMV data 95 includes data points such as current vehicle registrations, historical vehicle registrations, adults per household, frequency of vehicle exchange and other information. In one embodiment, this data is received in 15 day increments via web services. This process is indicated in logic block 248.

The Augmented Sales database 115 is the repository for data polled from the Dealer management Systems 170 and the State Governments' Vehicle Registration databases 95. The transaction pairing service provider platform 100 consistently builds as close to a real-time data store 115 as possible of nationwide sales and inventory data cross-referenced with data from various other data providers. This data is used in the Transaction Pairing engine 252 to make the system accurate and timely.

The Transaction Pairing engine 252 encompasses the correlation of incoming leads to sales outcomes at the dealer level. The matching process of the Transaction Pairing engine 252 is a combination of operations performed on augmented (i.e., acquired) lead data stored in Acquired Leads database 110 and augmented sales data stored in Augmented Sales database 115. The incoming sales data is used to build a profile which includes variables such as name, address, home phone, cell phone, aliases, postal and proprietary (databases) address moves. Once a high-degree of relationship between an incoming lead and sales outcome is reached, the correlation is passed to the Paired Leads and Sales Records database 120 that holds the outcomes of the connections discovered (matches) between incoming leads, cars sold at the dealer level (DMS database 170) and reconciled with the department of motor vehicles/motor vehicle authorities in all 50 states.

Compensation due from each dealer for a successful lead conversion is determined by Asynchronous Transaction Clearing engine 256. The Asynchronous Transaction Clearing engine 256 prevents gaming of the “Pay for Performance” platform by dealers. Each time a new transaction is recorded the asynchronous transaction clearing process runs. The latest transaction is read and analyzed to determine the transaction amounts and which accounts (i.e., dealer and lead provider) are affected. The Transaction Clearing engine 256 determines which method of compensation is in effect for the lead provider (either a flat fee or percentage of economic transaction), loads the affected account rates, and computes fees. The debits and credits are then recorded to the appropriate accounts. The journal entries are then written to the t-accounts in the ledger table. A trial balance is computed to verify that the sum of the debits is equal to the sum of the credits. System financial statements are computed and associated metrics are updated. The balances of the temporary accounts are then transferred to the affected accounts. The final trial balance is calculated after the last transaction is read. Transaction Clearing engine 256 then checks for orphan leads found in both the Augmented Leads database 110 and the state vehicle registration database 95, but not in the Dealer Management System database 170. If any orphan leads are found, the transaction is loaded and analyzed as described in the Augmented Leads store 110 and the State Vehicle Registration database 95 and the accounts affected are determined. If pairing the dealer and provider between records in the Augmented Sales store 115 and records in the Augmented Leads store 110 is successful, the next action is to adjust entries. Regardless of the length of time that has elapsed, the Transaction Clearing engine 256 adjusts monies owed by the dealer to the lead publisher, journalizes the entries, and posts adjustments to the correct “to-accounts” table. The trial balance is then adjusted and a new trial balance is computed with fees due to the lead publisher extracted from the dealer's account with the transaction pairing service provider.

The Dealer Rating engine 260 creates an accurate and complete view of any dealer's (e.g., franchise or independent) performance. The Dealer Rating engine 260 obtains velocity metrics such as the lead cycle time which measures the time from when the initial lead was received for a consumer to the time at which a completed sale occurs. The Dealer Rating engine 260 also uses the direct financial transaction data from the Dealer Management System database 170 to obtain transaction profitability and sales rates versus periodic averages. Advertising efficiency is measured through computation of variable closing percentages. Inventory efficiency is also a factor in determining inventory turnover compared to several aspects of a dealership's competitive landscape and several tiered levels. A dealer's customer loyalty is examined through instances of multiple first degree transactions and correlations to second and third degree influences. The lead fill rate is then determined. The lead fill rate is a measure that takes into account the internal sales organization's capacity to carry the dealership's expenses. A measure of one (1) or greater is the goal. Through these and various other measures, Dealer Rating engine 260 determines a weighted measure of performance in index form. The performance index obtained is then discounted by running a dealer gaming prediction model to bring the risk tolerance that this dealer, or other dealers, will try to game or otherwise defraud the Transaction Pairing system. Each transaction pairing of leads and sales updates the performance index measures for the entire Transaction Pairing system.

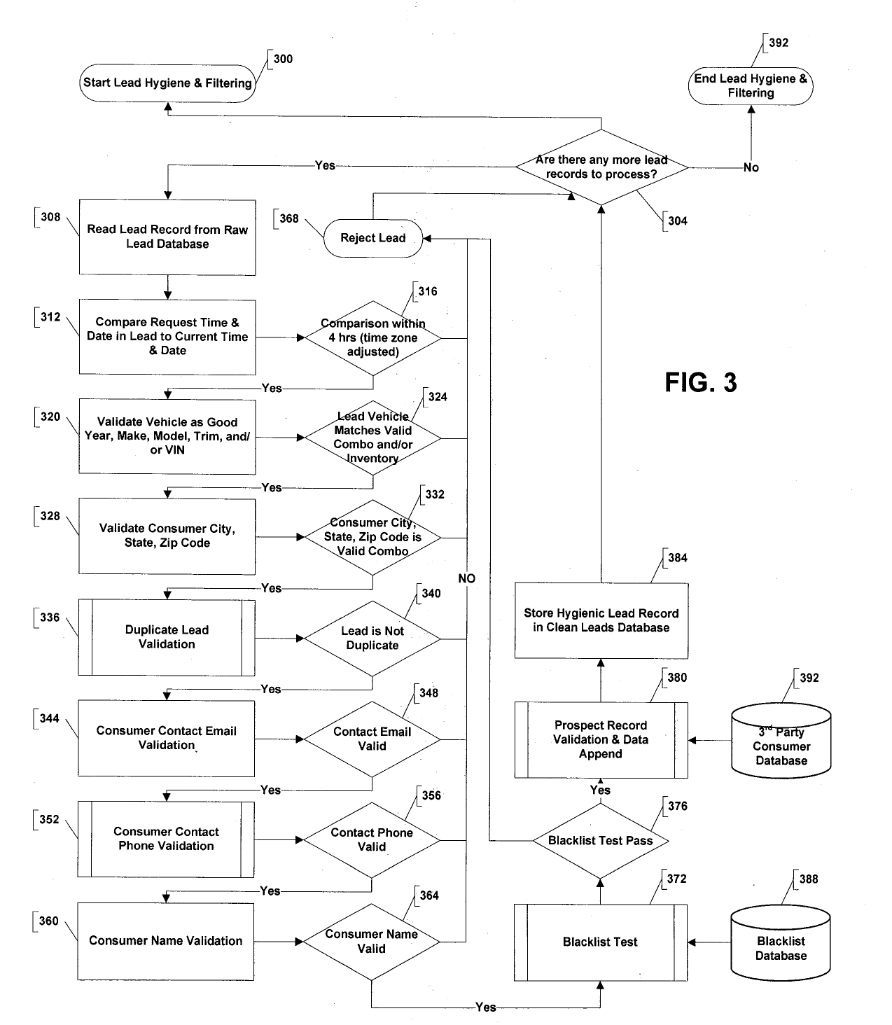

The following paragraphs describe the exemplary processing engines of the platform in greater detail. FIG. 3 illustrates the processing logic for the Lead Hygiene engine 220 which filters and validates leads stored in the Raw Leads database 105 in an exemplary embodiment. The process for lead hygiene and filtering begins in logic block 300. In decision block 304, a test is performed to determine if there are any more leads to process in Raw Leads database 105. If there are no additional leads to process, the lead hygiene and filtering process ends as indicated in block 392. If there are additional leads to process in decision block 304, a lead record is read from the lead table (i.e., Raw Leads database 105) as indicated in block 308.

A series of comparisons and decision steps are then performed on the lead. A failure of any decision test results in the lead being rejected as indicated in block 368. The request time and date associated with the lead is compared to the current time and date as indicated in block 312. This step is followed by comparing the request time/date to the current time/date in decision block 316 to determine if the request time is within a pre-specified number of hours of the current time. In one embodiment, the time differential can be four hours. If the time differential exceeds the pre-specified number of hours, the lead is rejected as being stale (block 368). For a lead that is not older than the pre-specified number of hours, information on the desired product (e.g. vehicle year, make, model, trim, and/or vehicle identification number (VIN)) is validated as indicated in block 320. Next, in decision block 324, a test is performed to determine if the lead product information matches a valid combination of features and/or inventory. If the lead product information matches a valid combination of features and/or inventory, the consumer's residence information is validated next as indicated in block 328. A test is performed in decision block 332 to determine if the consumer residence information is a valid combination. If the consumer residence information is found valid, a duplicate lead validation process is performed as indicated in block 336. A test is performed in decision block 340 to determine if the lead is a duplicate. If the lead is found not to be a duplicate, then consumer contact email validation is performed as indicated in block 344. In decision block 348, a test is performed to determine if the consumer contact email is valid. If the contact email address is found valid in decision block 348, consumer contact phone number is validated as indicated in block 352. A test is performed in decision block 356 to determine if the contact phone number is valid. If the contact phone number is found valid in decision block 356, consumer name validation is performed as indicated in block 360. In decision block 364, a test is performed to determine if the consumer name is valid. If the consumer name is found valid, a blacklist test process for the lead is initiated as indicated in block 372 using data stored in blacklist database 388. A lead having a match with an entry in the blacklist is rejected.

In decision block 376, a test is performed to determine if the lead passed the blacklist test. If the lead does not pass the test, the lead is rejected (block 368). If the lead passes the blacklist test (i.e., no matching entry in blacklist database), a prospect record validation and data append process is initiated in block 380 using data stored in third party consumer database 392. Following the prospect record validation and data append process in block 380, the hygienic lead record is stored in Clean Leads database 108. Processing logic returns to decision block 304 to determine if there are any additional leads to process in Raw Lead database 105.

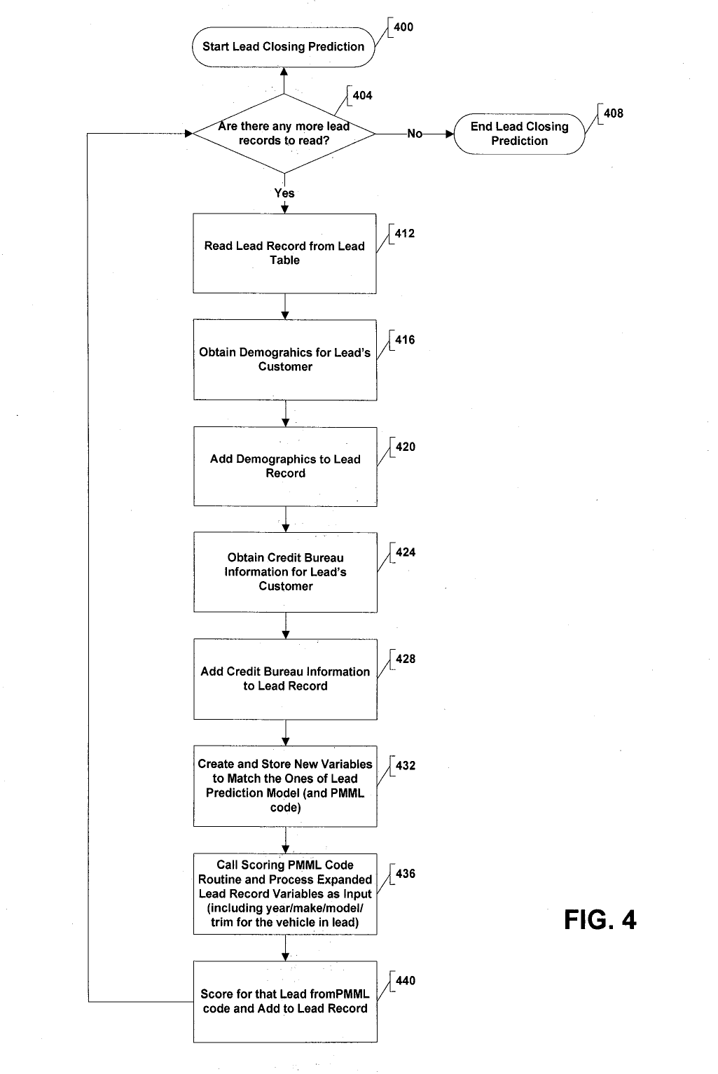

FIG. 4 illustrates the processing logic for the Lead Closing Prediction engine 224 which predicts closings for leads stored in the Clean Leads database 108 in an exemplary embodiment. The Lead Closing Prediction engine 224 uses the Predictive Model Markup Language (PMML) which is the de facto standard for representing predictive modeling techniques in Extensible Markup Language (XML). Various modeling and statistical techniques, approved by the data mining community, are included in the most recent release of PMML. These techniques include association rules, cluster models, decision trees, neural networks, regression, and rule sets along with others. Such techniques allow the extraction of patterns from historical data that analysts might not discern. Patterns in the data are used to predict results based on the input data.

The process for predicting lead closing begins in block 400. In decision block 404, a determination is made as to whether or not there are any more leads to read for closing prediction in Clean Leads database 108. If there are no additional leads to read, the processing logic for lead closing prediction ends as indicated in block 408. If there are more leads to process, a lead record is read from the clean leads database 108 as indicated in block 412. Demographics for the customer (i.e., lead) are obtained as indicated in block 416 and added to the lead record in block 420. Credit bureau information is then obtained for the customer as indicated in block 424, and added to the lead record in block 428. New variables to match the variables of the lead prediction model (and PMML code) are created and stored as indicated in block 432. The PMML code routine for scoring is then called and the expanded lead record variables are processed as inputs (e.g., year, make, model, trim for vehicle in lead), as indicated in block 436. The score obtained for the lead from the PMML code is added to the lead record as indicated in block 440. Logic processing then returns to decision block 404 to determine if there are any additional leads to read in Clean Leads database 108.

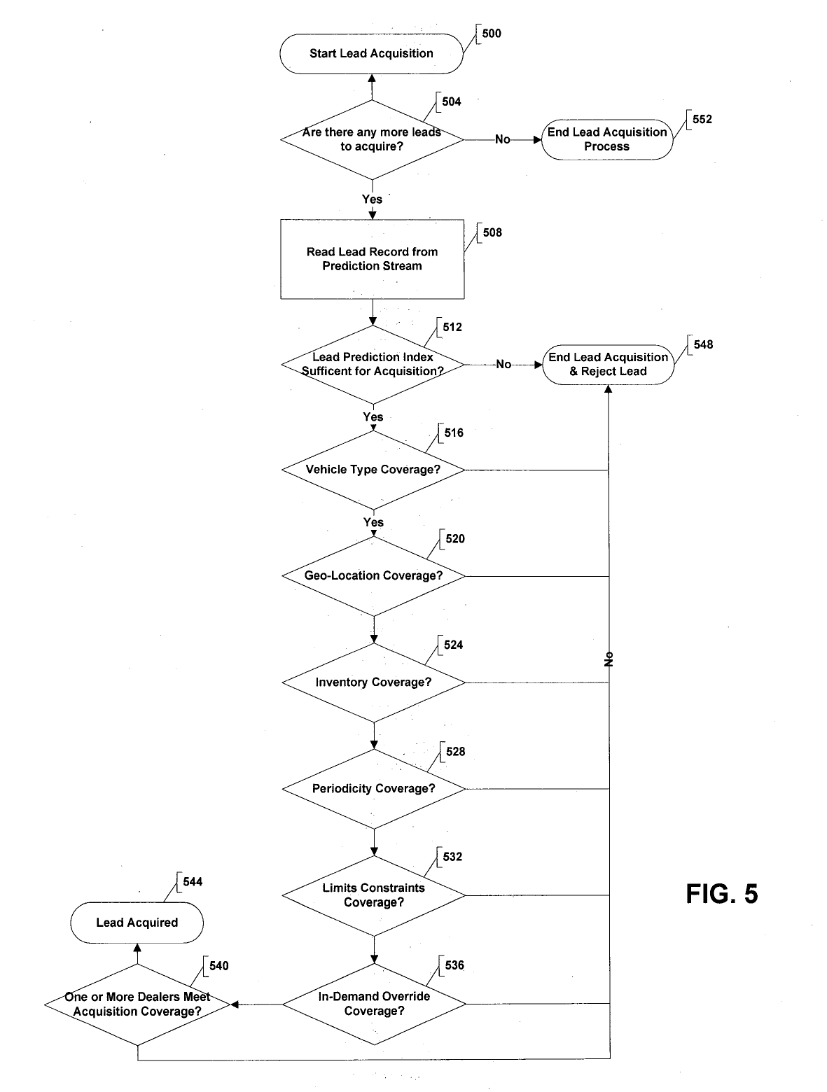

FIG. 5 illustrates the processing logic for the Lead Acquisition engine 228 in an exemplary embodiment. The process for lead acquisition begins in block 500. In decision block 504, a determination is made as to whether or not there are any more leads to acquire from Lead Closing Prediction engine 224. If there are no additional leads to acquire, the processing logic for lead acquisition ends as indicated in block 552. If there are more leads to acquire in decision block 504, a lead record is read from the prediction stream as indicated in block 508.

A series of comparisons and decision steps are then performed on the streamed lead record. A failure of any decision test results in the streamed lead being rejected as indicated in block 548. A lead prediction index is determined for the lead record from the prediction stream and a determination is made in decision block 512 whether or not the lead prediction index is sufficient for lead acquisition. If the lead prediction index is sufficient for lead acquisition (i.e., exceeds a predetermined threshold value), a vehicle type coverage test (i.e., condition, year, make, model, trim) is performed in decision block 516. This is followed by a geo-location test (i.e., consumer's geographical location weighed against configured consumption controls) in decision block 520, an inventory coverage test (i.e., active inventory check) in decision block 524, a periodicity coverage test (i.e., configured according to system timestamp) in decision block 528, a limits of consumption constraints coverage test in decision block 532, an in-demand override coverage test in decision block 536, and a test in decision block 540 to determine if one or more dealers meet acquisition coverage. Successfully passing each of the aforementioned tests results in the lead being acquired as indicated in block 544.

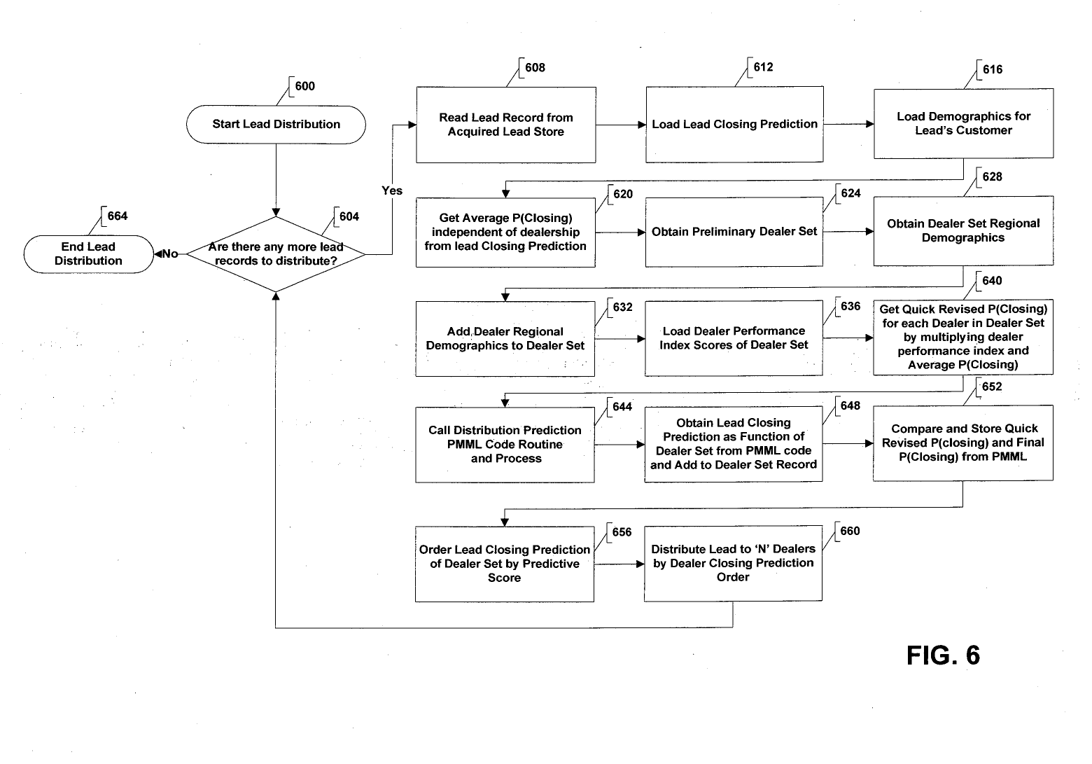

FIG. 6 illustrates the processing logic for the Lead Distribution engine 240 in an exemplary embodiment. The process for lead distribution begins in block 600. In decision block 604, a determination is made as to whether or not there are any more lead records to distribute from Augmented Leads database 110. If there are no additional leads to distribute, the processing logic for lead distribution ends as indicated in block 664. If there are more leads to distribute in decision block 604, a lead record is read from the Acquired Leads store 110 as indicated in block 608. The Lead Distribution engine 240 then loads the lead closing prediction as indicated in block 612 and the demographics for the lead's customer as indicated in block 616. The average probability of closing independent of the lead closing prediction is obtained as indicated in block 620.

A preliminary dealer set is obtained as indicated in block 624 and regional demographics are obtained for the dealer set in block 628. Dealer regional demographics are added to the dealer set as indicated in block 632. The dealer performance index scores for the set of dealers is loaded as indicated in block 636. A revised probability of closing is determined for each dealer in the dealer set by multiplying the dealer performance index and the average probability of closing as indicated in block 640. Next, the distribution prediction PMML code routine is called and executed as indicated in block 644. The lead closing prediction is determined as a function of the dealer set from execution of the PMML code and added to the dealer set record as indicated in block 648. A comparison of the revised probability of closing and the final probability of closing from the PMML code is performed and the results are stored as indicated in block 652. The lead closing prediction of the dealer set is then ordered by the predictive score as indicated in block 656. The lead is distributed to “n” dealers based on the dealer closing prediction order as indicated in block 660. Processing logic then returns to decision block 604 to determine if there are any additional leads to distribute.

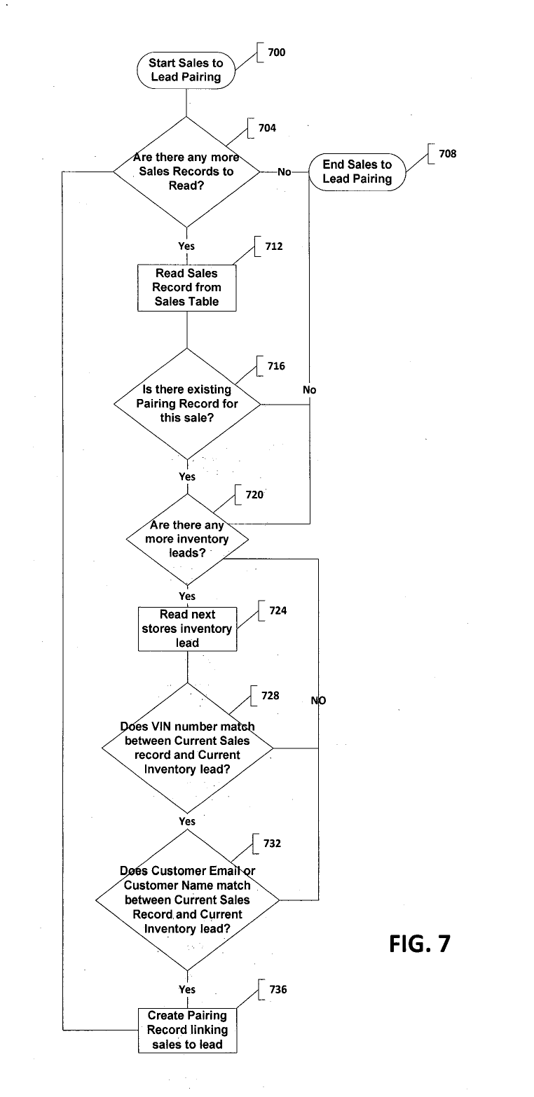

FIG. 7 illustrates the processing logic for Transaction Pairing engine 252 that matches sales to lead inventory in an exemplary embodiment. The process for pairing sales to leads begins in block 700. In decision block 704, a determination is made if there are any more sales records to read from Augmented Sales database 115. If there are no sales records to read, the pairing process terminates as indicated in termination block 708. If there is at least one additional sales record to process in decision block 704, the sales record is read from Augmented Sales database 115 as indicated in block 712. Next, in decision block 716, a determination is made as to whether or not there is an existing pairing record for this sale. If there is no existing pairing record, the processing logic returns to decision block 704 to determine if there are any more sales records to read. If there is an existing pairing record for this sale, then a determination is made in decision block 720 as to whether or not there are any additional leads to process in Augmented Leads database 110. If there are no additional augmented leads to process, processing logic returns to decision block 704 to determine if there are any more sales records to process in Augmented Sales database 115. If there are additional augmented leads to process, the next inventory lead stored in Augmented Leads database 110 is read as indicated in block 724.

In decision block 728, a determination is made whether or not the vehicle identification number (VIN) between the sales record and inventory lead matches. If the VINs do not match, processing logic returns to decision block 720 to determine if there are any additional augmented leads to process. If the VINs match, a determination is made in decision block 732 whether or not the customer email or customer name match between the sales record and the inventory lead. If there is no match of customer email/customer name between sales record and augmented lead, processing logic returns to block 724 to read the next inventory lead stored in Augmented Leads database 110. If customer email/customer name match between sales record and augmented lead, a pairing record is created linking the sales record to the lead as indicated in logic block 736. Processing logic then returns to decision block 704 to determine if there are any additional sales records to read.

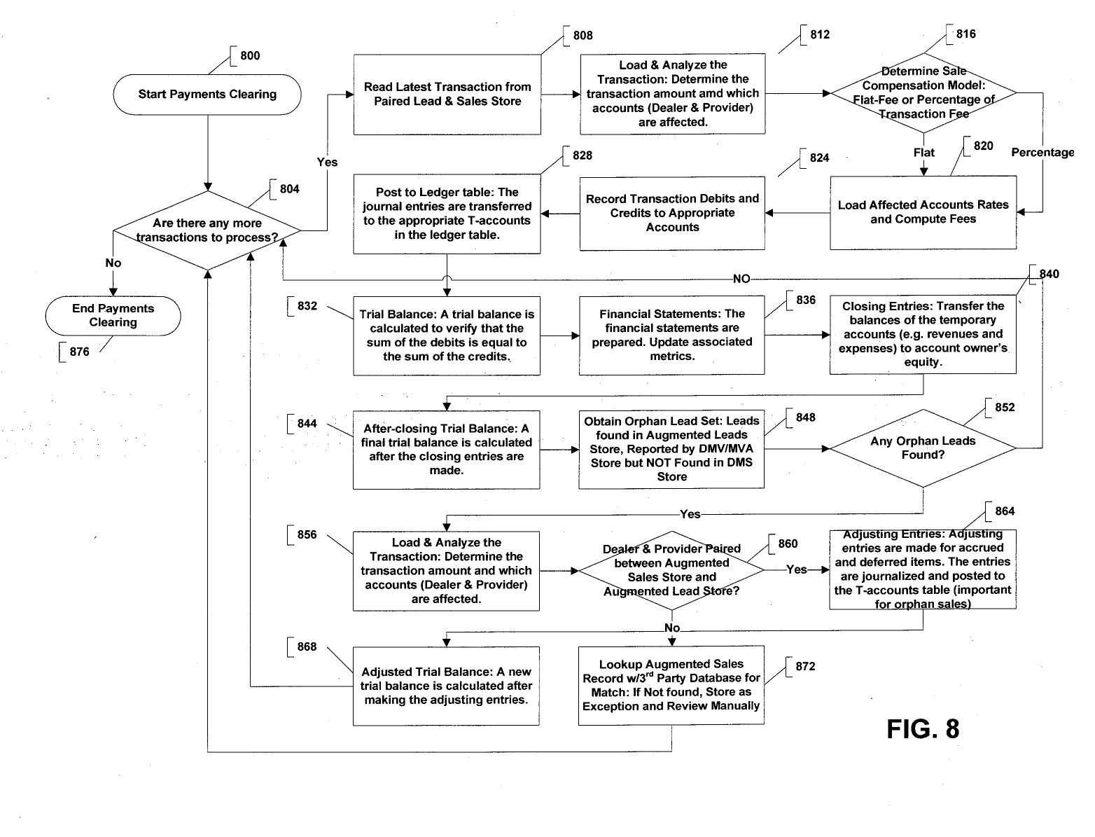

FIG. 8 illustrates the processing logic for the Asynchronous Transaction Clearing engine 256 in an exemplary embodiment. The process for asynchronous transaction clearing begins in block 800. In decision block 804, a determination is made as to whether or not there are any more transactions to process in Paired Leads and Sales database 120. If there are no additional transactions to process, the processing logic for the Asynchronous Transaction Clearing engine 256 terminates. If there are additional transactions to process, the latest transaction is read from the Paired Leads and Sales database 120, as indicated in block 808. The transaction is loaded and analyzed to determine the transaction amount and the affected dealer and lead provider. These steps are indicated in block 812. In decision block 816, a determination is made as to the sales compensation model that is applicable to the transaction. Regardless of whether the sales compensation model is a flat fee or a percentage of the transaction fee, the rates for the affected accounts are loaded and the fees due are computed as indicated in block 820. Next, transaction debits and credits are recorded to the appropriate accounts as indicated in block 824. This is followed by posting journal entries to appropriate t-accounts in the general ledger table as indicated in block 828. A trial balance is calculated to verify that the sum of the debits equals the sum of the credits in block 832. Financial statements are prepared and associated metrics are updated as indicated in block 836. The balances of the temporary accounts (e.g., revenues and expenses) are transferred to the account owner's equity balance as indicated in block 840. A final trial balance is calculated after these closing entries are made as indicated in block 844.

The Transaction Clearing engine 256 next checks for orphan leads as indicated in block 848. Orphan leads are leads found in Augmented Leads database 120 and reported by the DMV/MVA database 95, but not found in Dealer Management System database 170. A test for orphan leads is made as indicated in decision block 852. If no orphan leads are found, processing logic returns to decision block 804 to determine if there are additional transactions to process. If orphan leads are found, the transactions are loaded and analyzed as indicated in block 856. This includes determining the transaction amount and affected dealer and lead provider accounts for each orphan lead. In decision block 860, a determination is made whether or not the orphan leads have been paired between the dealer in the Augmented Sales store 115 and the lead provider in the Augmented Leads database 120. If the dealer and lead provider are successfully paired, entries are adjusted for accrued and deferred items as indicated in block 864. This includes journalizing entries and posting the entries to the t-accounts table. This last step is important for capturing orphan sales. An adjusted trial balance is then determined after making the adjusting entries as indicated in block 868. Processing logic returns to decision block 804 to determine if there are additional transactions to process. If the dealer and lead provider are not successfully paired in decision block 860, a lookup for the augmented sales record is performed with a third party database as indicated in block 872. If a match is not found, the augmented sales record is stored as an exception and reviewed manually. Processing logic returns to decision block 804 to determine if there are additional transactions to process.

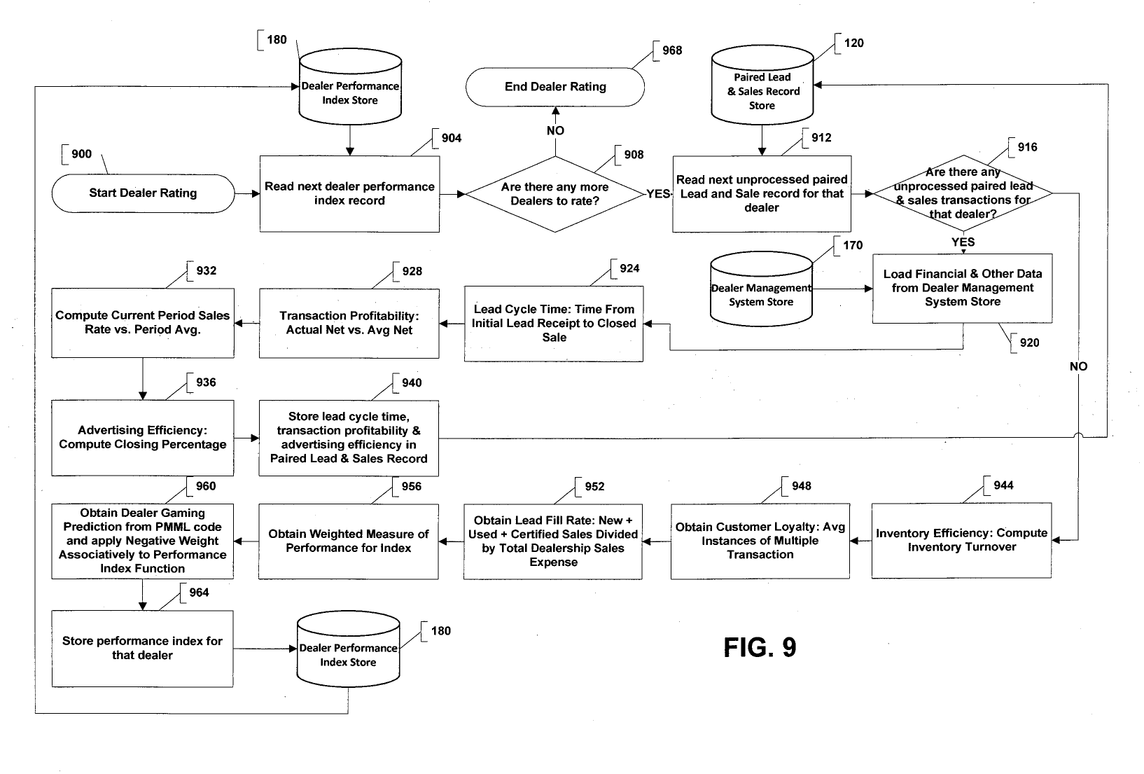

FIG. 9 illustrates the processing logic for the Dealer Rating engine in an exemplary embodiment. The process for dealer rating begins in block 900. The next dealer performance index record is read from Dealer Performance Index database 180 as indicated in block 904. A determination is made in decision block 908 if there are any more dealers to rate. If there are no more dealers to rate, processing logic terminates in block 968. Otherwise, the next unprocessed paired lead and sales record for the dealer is read as indicated in block 912. A test is performed to determine if there are any unprocessed paired leads and sales transactions for the dealer in decision block 916.

If there are unprocessed paired leads and sales transactions for the dealer, financial and other data is loaded from the Dealer management System database 170 as indicated in block 920. This is followed by a determination of lead cycle time as indicated in block 924. Lead cycle time is the time from initial receipt of the lead until the sale is closed. Transaction profitability is then determined as indicated in block 928. This measure compares actual net profitability against average net profitability. The current period sales rate for the dealer is computed and compared with the dealer's average periodic sales rate as indicated in block 932. Next, the advertising efficiency is determined for the dealer as indicated in block 936. The lead cycle time, transaction profitability and advertising efficiency are then stored in Paired Leads and Sales database 120. Advertising efficiency is measured through a determination of lead/sale closing percentages.

In decision block 916, if there are no remaining unprocessed paired leads and sales transactions for the dealer, inventory efficiency (i.e., inventory turnover) is determined for the dealer as indicated in block 944. The dealer's customer loyalty is then determined based on the average instances of multiple transactions between consumer and dealer. This step is indicated in block 948. The lead fill rate is determined next as indicated in block 952. Lead fill rate is a performance measure based on sales of new, used, and certified pre-owned vehicles divided by the dealership's total sales expenses. A weighted measure of performance is determined in index form as indicated in block 956. The PMML code is executed to determine the dealer's likelihood of trying to “game” the system by failing to record a product sale in DMS database 170, as indicated in block 960. A negative weight associated with the performance index function is then applied to the dealer performance index. The performance index for the dealer is then stored in Dealer Performance Index database 180 as indicated in block 964.

Embodiments of the invention have been described as computer-implemented processes and system components. It is important to note, however, that those skilled in the art will appreciate that the mechanisms of the embodiments described are capable of being distributed as a program product in a variety of forms, and that the invention applies regardless of the particular type of non-transitory, computer readable storage medium utilized to carry out the distribution. Examples of non-transitory, computer readable storage media include, without limitation, recordable-type media such as CompactFlash cards, portable hard drives, diskettes, CD ROMs, memory sticks, and flash drives.

The corresponding structures, materials, acts, and equivalents of all means plus function elements in any claims below are intended to include any structure, material, or acts for performing the function in combination with other claim elements as specifically claimed. Those skilled in the art will appreciate that many modifications to the exemplary embodiments are possible without departing from the scope of the present invention.

In addition, it is possible to use some of the features of the embodiments disclosed without the corresponding use of the other features. Accordingly, the foregoing description of the exemplary embodiments is provided for the purpose of illustrating the principles of the invention, and not in limitation thereof, since the scope of the present invention is defined solely by the appended claims.

What is claimed:

1. A computer-implemented method for ensuring payment for a successful sales lead provided to a product vendor, comprising the steps performed by a computer system of:
receiving a plurality of customer leads from a lead provider web site, the customer leads including at least customer information and a product preference;
storing the customer leads in a plurality of records in a leads database;
filtering the plurality of lead records in the leads database to validate customer information and product availability;
applying a lead acquisition algorithm to the filtered lead records to determine a plurality of leads to acquire;
applying a lead distribution algorithm to determine at least one product vendor to send each acquired lead;
accessing a product vendor sales management database to determine the acquired leads that have resulted in product sales to customers associated with the acquired leads;
comparing the acquired leads stored in the leads database with the sales records stored in a sales database to determine matched pairings of acquired leads and product sales;
determining and billing a payment due from the at least one product vendor based on the matched pairings of acquired leads and product sales.

2. The computer-implemented method for ensuring payment of claim 1 further comprising determining a rating for a plurality of product dealers based on a frequency of conversion of acquired sales leads into product sales.

3. The computer-implemented method for ensuring payment of claim 2 wherein the step of determining at least one product vendor to send each acquired lead is based, at least in part, on the product dealer's rating.

4. The computer-implemented method for ensuring payment of claim 1 further comprising determining a score for each filtered lead record representing a likelihood of closing a product sale by applying a predictive analytics algorithm to customer information and product availability information.

5. The computer-implemented method for ensuring payment of claim 4 wherein the predictive analytics algorithm comprises at least one of a neural network model, association rules, a cluster model, a decision tree, a regression model, and a rules set.

6. The computer-implemented method for ensuring payment of claim 1 wherein determining matched pairings of acquired leads and product sales comprises matching product identification numbers between an acquired lead and a product sale.

7. The computer-implemented method for ensuring payment of claim 4 wherein determining matched pairings of acquired leads and product sales comprises matching customer information associated with the acquired leads with customer information associated with the products sales.

8. The computer-implemented method for ensuring payment of claim 4 wherein the step of determining a score for each filtered lead record further comprises obtaining demographic and credit rating information for the associated customer.

9. The computer-implemented method for ensuring payment of claim 1 further comprising selecting a product preference by the customer on the lead provider's web site.

10. The computer-implemented method for ensuring payment of claim 1 wherein the product preference comprises at least one of make, model, trim level, and vehicle identification number for a vehicle.

11. The computer-implemented method for ensuring payment of claim 1 further comprising accessing a product registration database to determine if there are any exceptions to the matching of acquired leads and product sales that are found in the product registration database.

12. The computer-implemented method for ensuring payment of claim 11 wherein one exception comprises an acquired lead having an associated product registration record, but no corresponding sales record in the vendor sales management database.

13. The computer-implemented method for ensuring payment of claim 1 wherein the lead acquisition algorithm comprises determining a lead prediction index that represents a likelihood of the lead resulting in a sale and is compared with a threshold value to determine if the lead should be acquired.

14. The computer-implemented method for ensuring payment of claim 1 wherein the lead distribution algorithm comprises determining a probability of closing a sale is based, at least in part, on weighting a product vendor's performance index by an average probability of closing a product sale that is independent of the product vendor's performance index.

15. The computer-implemented method for ensuring payment of claim 2 wherein determining a rating for each of a plurality of dealers further comprises weighting a product vendor's performance index by a probability of the product vendor failing to record a product sale.

16. A system for ensuring payment for a successful sales lead provided to a product vendor, comprising:
a storage medium for storing a plurality of customer leads from a lead provider in a leads database;
a storage medium for storing a plurality of sales records associated with the plurality of customer leads in a sales database;
a processor for executing a plurality of component including:
a component for receiving a plurality of customer leads from a lead provider web site, the customer leads including at least customer information and a product preference;
a component for filtering the plurality of lead records in the leads database to validate customer information and product availability;
a component for applying a lead acquisition algorithm to determine a plurality of leads to acquire;
a component for applying a lead distribution algorithm to determine at least one product vendor to send each acquired lead;
a component for accessing a product vendor sales management database to determine the acquired leads that have resulted in product sales to customers associated with the acquired leads;
a component for comparing the acquired leads stored in the leads database with a plurality of sales records stored in the sales database to determine matched pairings of acquired leads and product sales;
a component for determining and billing a payment due from the at least one product vendor based on the matched pairings of acquired leads and product sales.

17. The system for ensuring payment of claim 16 wherein the plurality of components executed by the processor further comprises a component for determining a rating for a plurality of product dealers based on a frequency of conversion of acquired sales leads into product sales.

18. The system for ensuring payment of claim 17 wherein determining at least one product vendor to send each acquired lead stored in the leads database is based at least in part on a product dealer's rating.

19. The system for ensuring payment of claim 16 further comprising a component for determining a score for each filtered lead record that applies a predictive analytics algorithm to customer information and product availability information.

20. The system for ensuring payment of claim 19 wherein the predictive analytics algorithm comprises at least one of a neural network model, association rules, a cluster model, a decision tree, a regression model, and a rules set.

21. The system for ensuring payment of claim 16 wherein determining matched pairings of acquired leads and product sales comprises matching product identification numbers between an acquired lead and a product sale.

22. The system for ensuring payment of claim 16 wherein determining matched pairings of acquired leads and product sales comprises matching customer information associated with the acquired leads with customer information associated with the products sales.

23. The system for ensuring payment of claim 19 wherein the component for determining a score for each lead record comprises a module for obtaining demographic and credit rating information for the associated customer.

24. The system for ensuring payment of claim 16 further comprising a component for enabling a customer to select a product preference on the lead provider's web site.

25. The system for ensuring payment of claim 16 further comprising a component for accessing a product registration database to determine if there are any exceptions to the matching of acquired leads and product sales found in the product registration database.

26. The system for ensuring payment of claim 16 wherein the component for applying the lead acquisition algorithm comprises a module for determining a lead prediction index that represents a likelihood of the lead resulting in a sale and comparing the lead prediction index with a threshold value to determine if the lead should be acquired.

27. The system for ensuring payment of claim 16 wherein the component for applying the lead distribution algorithm comprises a module for determining a probability of closing a sale is based, at least in part, on weighting a product vendor's performance index by an average probability of closing a product sale that is independent of the product vendor's performance index.

28. The system for ensuring payment of claim 17 wherein the component for determining a rating for each of a plurality of dealers further comprises a module for weighting a product vendor's performance index by a probability of the product vendor failing to record a product sale.

29. A computer program product for ensuring payment for a successful sales lead provided to a product vendor when executed on a processor, comprising a non-transitory computer readable storage medium having computer readable code embedded therein, the computer readable storage medium comprising:
program instructions that receive a plurality of customer leads from a lead provider, the customer leads including at least customer information and a product preference;
program instructions that store the plurality of customer leads in a leads database;
program instructions that filter the plurality of lead records in the leads database to validate customer information and product availability;
program instructions that apply a lead acquisition algorithm to determine a plurality of leads to acquire;
program instructions that apply a lead distribution algorithm to determine at least one product vendor to sell each acquired lead;
program instructions that access a product vendor sales management database to determine acquired leads that have resulted in product sales to customers associated with the acquired leads;
program instructions that compare the acquired leads stored in the leads database with a plurality of sales records stored in a sales database to determine matched pairings of acquired leads and product sales;
program instructions that determine and bill a payment due from the at least one product vendor based on the matched pairings of acquired leads and product sales.

30. The computer readable storage medium for ensuring payment of claim 29 further comprising program instructions that determine a rating for a plurality of product dealers based on a frequency of conversion of acquired sales leads into product sales.

31. The computer readable storage medium for ensuring payment of claim 30 wherein the program instructions that determine at least one product vendor to send each acquired lead stored are based, at least in part, on the product dealer's rating.

32. The computer readable storage medium for ensuring payment of claim 29 further comprising program instructions that determine a score for each filtered lead record by applying a predictive analytics algorithm to customer information and product availability information.

33. The computer readable storage medium for ensuring payment of claim 32 wherein the predictive analytics algorithm comprises at least one of a neural network model, association rules, a cluster model, a decision tree, a regression model, and a rules set.

34. The computer readable storage medium for ensuring payment of claim 29 wherein the program instructions that determine matched pairings of acquired leads and product sales match product identification numbers between an acquired lead and a product sale.

35. The computer readable storage medium for ensuring payment of claim 34 wherein the program instructions that determine matched pairings of acquired leads and product sales match customer information associated with the acquired leads with customer information associated with the products sales.

36. The computer readable storage medium for ensuring payment of claim 32 wherein the program instructions that determine a score for each filtered lead record obtain demographic and credit rating information for the associated customer.

37. The computer readable storage medium for ensuring payment of claim 29 further comprising program instructions that enable a customer to select a product preference on the lead provider's web site.

38. The computer readable storage medium for ensuring payment of claim 29 wherein the product preference comprises at least one of make, model, trim level, and vehicle identification number for a vehicle.

39. The computer readable storage medium for ensuring payment of claim 29 further comprising program instructions that access a product registration database to determine if there are any exceptions to the matching of acquired leads and product sales found in the product registration database.

40. The computer readable storage medium for ensuring payment of claim 39 wherein one exception comprises an acquired lead having an associated product registration record, but no corresponding sales record in the vendor sales management database.

41. The computer readable storage medium for ensuring payment of claim 33 wherein the program instructions that apply the lead acquisition algorithm comprise program instructions that determine a lead prediction index that represents a likelihood of the lead resulting in a sale and compare the lead prediction index with a threshold value to determine if the lead should be acquired.

42. The computer readable storage medium for ensuring payment of claim 33 wherein the program instructions that apply the lead distribution algorithm comprise program instructions that determine a probability of closing a sale based, at least in part, on weighting a product vendor's performance index by an average probability of closing a product sale that is independent of the product vendor's performance index.

43. The computer readable storage medium for ensuring payment of claim 30 wherein the program instructions that determine a rating for each of a plurality of dealers further comprise program instructions that weight a product vendor's performance index by a probability of the product vendor failing to record a product sale.
